(19) United States
(12) Patent Application Publication
(10) Pub. No.: US 2007/0039175 A1
(43) Pub. Date: Feb. 22, 2007

(54) Methods for repairing turbine engine components

(75) Inventors: Michael Howard Rucker, Cincinnati, OH (US); Bhupendra Kumar Gupta, Cincinnati, OH (US); Nripendra Nath Das, Westchester, OH (US); David Edwin Budinger, Loveland, OH (US)

Correspondence Address: JOHN S. BEULICK (12729);C/O ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/184,154

(22) Filed: Jul. 19, 2005

(51) Int. Cl. B23P 6/00; B22D 19/10

(52) U.S. Cl. 29/889.1; 29/402.18; 29/402.09

(57) ABSTRACT

A method for repairing a turbine component includes identifying a crack in a surface of the component and applying a fluoride mixture to the surface of the component containing the crack. The method also includes exposing the portion of the component including the fluoride mixture to a controlled atmosphere and returning the repaired surface of the component to predetermined dimensions.

### BACKGROUND OF THE INVENTION

This invention relates generally to gas turbine engine components, and more particularly, to methods for repairing gas turbine engine components.

During operation of gas turbine engines, at least some components, for example shrouds, air foils, and/or turbine nozzles, within the engine, may be exposed to high temperature gases. Accordingly, to facilitate reducing the effects of exposure to such temperatures, at least some known turbine components are coated with a protective thermal barrier coating. For example, known thermal barrier coatings, such as, aluminide coatings, facilitate providing the components with an effective barrier against oxidation and/or corrosion of the component. However, over time, cycling of the engine and continuous exposure to high temperature gases can cause the aluminide layer to erode and may cause stress cracks to develop within the component.

Typically, during repair of cracked components, reactive cleaning chemicals may be applied to facilitate removing deposits of oxides and combustion products form the surface of the component being repaired. However, with at least some known cleaning methods, when the component is exposed to the highly reactive chemical gases may undesirably remove or denigrate the protective aluminide layer from areas of the component other than the cracked surface to be repaired, thus degrading the structural properties of the components.

### BRIEF DESCRIPTION OF THE INVENTION

In one aspect, a method for repairing a turbine component is provided. The method includes identifying a crack in a surface of the component and applying a fluoride mixture to the surface of the component containing the crack. The method also includes exposing the portion of the component including the fluoride mixture to a controlled atmosphere and returning the repaired surface of the component to pre-determined dimensions.

In another aspect, method for repairing a component is provided. The method includes applying a fluoride mixture to a first portion of the component such that the fluoride mixture is compresses into a crack in the component and such that the remainder of the component is not contacted by the fluoride mixture and heat-treating the portion of the component including the fluoride mixture for a pre-determined period of time. The method also includes repairing the crack and removing excess material from the component until the repaired surface of the component is returned to pre-determined dimensions.

### BRIEF DESCRIPTION OF THE DRAWINGS

FIG. 1 is a cross-sectional side view of an exemplary gas turbine engine;

FIG. 2 is an enlarged cross-sectional side view of a shroud assembly segment that may be used with the gas turbine engine in FIG. 1;

FIG. 3 is an enlarged a cross-sectional view of the shroud assembly segment shown in FIG. 2 during an initial stage of repair; and

FIG. 4 is a flow chart illustrating an exemplary method for use in repairing a damaged component.

### DETAILED DESCRIPTION OF THE INVENTION

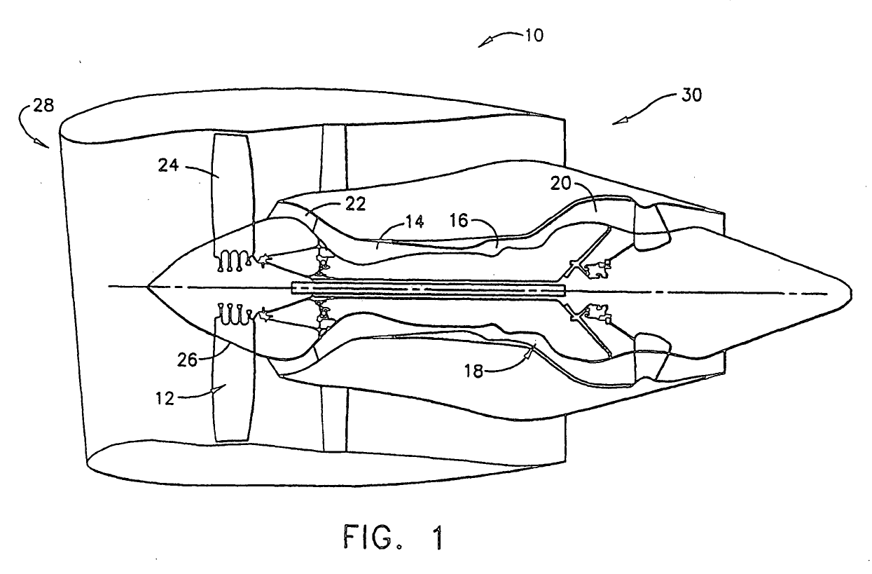

FIG. 1 is a schematic illustration of an exemplary gas turbine engine 10 including a fan assembly 12, a high pressure compressor 14, and a combustor 16. Engine 10 also includes a high pressure turbine 18, a low pressure turbine 20, and a booster 22. Fan assembly 12 includes an array of fan blades 24 extending radially outward from a rotor disc 26. Engine 10 has an intake side 28 and an exhaust side 30. In one embodiment, gas turbine engine 10 is a CF6-80 engine commercially available from General Electric Company, Cincinnati, Ohio.

In operation, air flows through fan assembly 12 and compressed air is supplied to high pressure compressor 14. The highly compressed air is delivered to combustor 16. Airflow from combustor 16 drives turbines 18 and 20, and turbine 20 drives fan assembly 12.

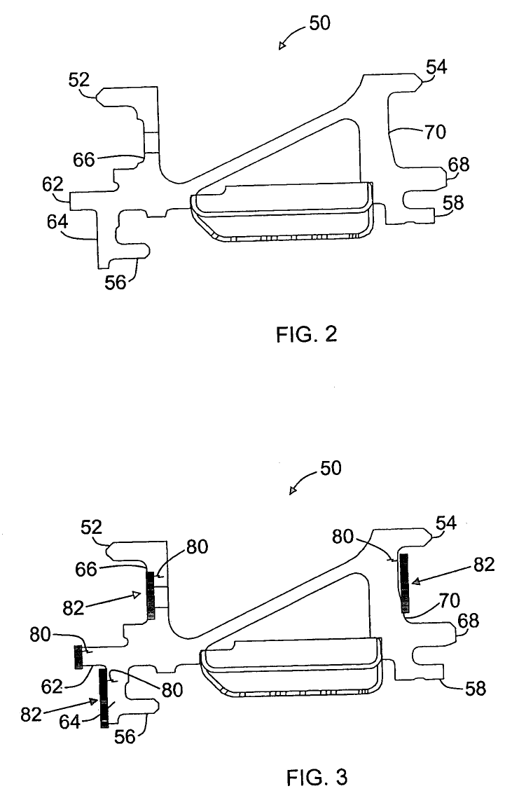

FIG. 2 is an enlarged cross sectional view of a shroud assembly segment 50 that may be used with a gas turbine engine, such as gas turbine engine 10 (shown in FIG. 1). Shroud assembly segment 50 includes a forward mounting flange 52 and an aft mounting flange 54 used to couple shroud assembly segment 50 to case segment (not shown).

Shroud assembly segment 50 includes a forward mounting hook 56 and an aft mounting hook 58 use to couple a shroud segment 60 to shroud assembly segment 50. In the exemplary embodiment, hook 56 extends radially inward and afterward from flange 52, and hook 58 extends radially inward and afterward from flange 54.

A forward flange 62 is positioned between flange 52 and hook 56 for coupling shroud assembly segment 46 to an adjacent stator assembly (not shown). Specifically, flange 62 extends axially forward of hook 56 such that a contact surface 64 is defined between flange 62 and hook 56. A flange face 66 is defined between flange 62 and flange 52. An aft flange 68 extends afterward between flange 54 and hook 58. An aft flange face 70 is defined between flange 68 and flange 54.

FIG. 3 An exemplary embodiment of a turbine engine component is described below in detail. Specifically, shroud assembly segment 50 is an example of a gas turbine engine component, and has been selected for illustrative purposes only. Each assembly segment 50 is not limited to the specific embodiments described herein. In the exemplary embodiment, shroud assembly segment 50 is fabricated from a high temperature super-alloy based on at least one of iron-base alloy, a nickel-base alloy, a cobalt-base alloy, and a titanium-base alloy, including a metallic environmental resistant overlay coating containing aluminum.

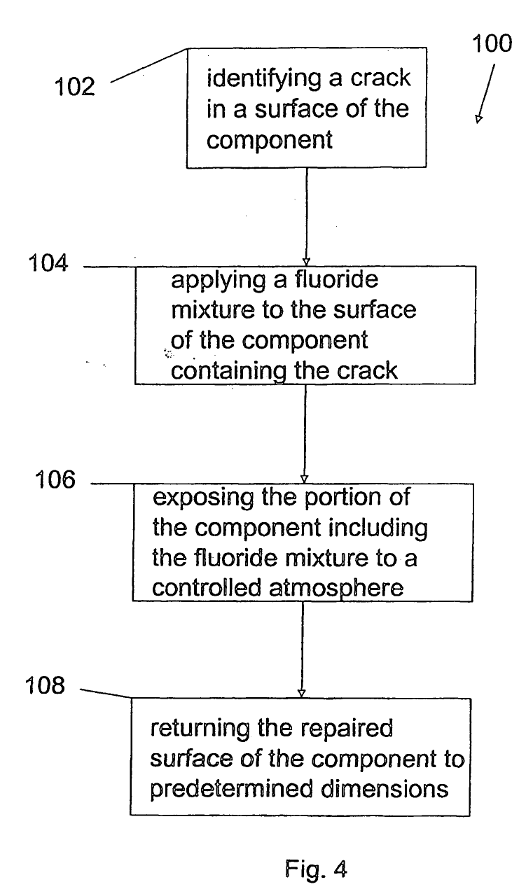

FIG. 4 is a flow chart 100 illustrating an exemplary method for repairing a damaged component. The invention can be practiced on any turbine engine component, which is also known as a substrate article. In the exemplary embodiment, the invention is practiced on shroud assembly segment 50. During engine operation, segment 50 is exposed to high temperatures and high stresses. As a result, cracks, fissures, breaks, or openings 80 may develop in the shroud assembly segments 50. Generally, such cracks extend from the barrier coating outer surface generally inwardly through the barrier coating and into the super-alloy material.

The first step in repairing the damaged component is to identify 102 cracks 80 in the outer surface of the shroud assembly segment 50. In the exemplary illustrative embodiment, cracks 80 have formed in the outer surfaces of flange 62, contact surface 64, channel 66, and channel 70.

Prior to repair, the component must be cleaned adjacent the identified cracks to facilitate removing oxides which may have built up on the surface of the component adjacent the crack to repaired. In the exemplary embodiment, only the specific locations of cracks 80 are cleaned rather than subjecting the entire component to the cleaning process. Specifically, the outer surface of crack 80 is initially cleaned using conventional cleaning methods including, but not limited to, grit blasting.

Following surface cleaning, the fluoride mixture is applied 104 to the component crack 80. The fluoride mixture includes at least one of a fluoride, chromium, aluminum chromium alloy, silicon aluminum alloy, titanium aluminum alloy, vanadium, vanadium aluminum alloy, cobalt aluminum and/or any combination thereof In the exemplary embodiment, the fluoride mixture is formed into a paste and/or highly compressed tape 82.

Tape 82 is positioned against the crack 80 and compressed into and against the crack 80 for a pre-determined time and at a pre-determined temperature. Tape 82 facilitates providing fluoride ions which can penetrate the crack 80 and facilitate removing oxides from the inside surfaces of the crack. By limiting exposure to just cracks 80, fluoride tape 82 facilitates reducing the detrimental effects of cleaning to the surrounding undamaged component surfaces. Additionally, reduced exposure substantially improves the component quality thus facilitating an increase in product life, durability, and reduced cycle time.

The portion of the component including the fluoride mixture is then exposed 106 to a reactive gas at a pre-determined temperature for a pre-determined time period. In the exemplary embodiment, the gas is hydrogen gas, that is at a temperature of between approximately between 1800° F. and 2000° F. In one embodiment, the component is exposed to the gas for a time period of between approximately two and six hours. In alternative embodiments, shroud assembly segment 50 is exposed to any reactive gas that enables the repair methods described herein to be performed as described herein. In one embodiment, known heat-treatment equipment, such as, for example, a hydrogen atmosphere retort in an air furnace is used. In alternative embodiments, it will be readily recognized by those skilled in the art that any means can be used to provide gaseous hydrogen and heat for a period of time.

Following the heat-treatment, the area of the component surface adjacent the crack 80 is then cleaned with a water-based compound and subject to a light grit blast. Crack 80 is then ready for repair. It will be readily recognized by those skilled in the art that any repair method can be used to repair crack 80. In one embodiment, repair includes flowing a healing-type alloy into crack 80 under a vacuum and them allowing the alloy to wet and diffuse with walls of crack 80. In another embodiment, the repair method includes heating and isostatically pressing the walls of cleaned crack 80 together. Finally, once crack 80 has been repaired, the surface of the component is machined and returned 108 to pre-determined dimensions.

The present invention provides a method for cleaning/removing complex oxides from within a narrow crack in an air turbine component through the application of a fluoride mixture formed into paste or tape ions on the location of the crack and then repairing such cleaned crack. Gas turbine components are costly to manufacture and constant exposure to potentially harsh chemical gases degrade the chemical/mechanical properties of the components, a localized and tailored method preferable than a generalized method.

The present invention has been described in connection with specific examples and combinations of materials and structures. However, it should understood that they are intended as exemplary, rather than in any way limiting the scope of the invention. The methods described herein may be utilized independently and separately with other components other than those described herein. Moreover, the methods can also be used to repair components other than turbine components.

While the invention has been described in terms of various specific embodiments, those skilled in the art will recognize that the invention can be practiced with modification within the spirit and scope of the claims.

What is claimed is:

1. A method for repairing a turbine component, said method comprising:
identifying a crack in a surface of the component;
applying a fluoride mixture to the surface of the component containing the crack;
exposing the portion of the component including the fluoride mixture to a controlled atmosphere; and
returning the repaired surface of the component to pre-determined dimensions.

2. A method in accordance with claim 1 wherein applying a fluoride mixture to the surface of the component further comprises removing contaminants from the outer surface of the component adjacent to the crack to be repaired.

3. A method in accordance with claim 1 wherein applying a fluoride mixture further comprises applying at least one of a fluoride mixture paste and a fluoride mixture compressed tape into the surface crack.

4. A method in accordance with claim 1 wherein exposing the portion of the component including the fluoride mixture further comprises exposing the fluoride mixture to a controlled hydrogen atmosphere.

5. A method in accordance with claim 1 wherein exposing the portion of the component including the fluoride mixture further comprises exposing the fluoride mixture to a controlled atmosphere at a temperature of between approximately 1800° F. and 2000° F. for a pre-determined amount of time.

6. A method in accordance with claim 5 wherein exposing the fluoride mixture to a controlled atmosphere further comprises exposing the fluoride mixture to a controlled atmosphere for period of time between approximately two to six hours.

7. A method in accordance with claim 1 wherein returning the surface of the component to pre-determined dimensions further comprises removing excess material from the component until the pre-determined dimensional are satisfied.

8. A method in accordance with claim 1 wherein exposing the portion of the component including the fluoride mixture to a controlled atmosphere further comprises heat-treating the portion of the component being repaired to a controlled atmosphere at a specific temperature for a pre-determined amount of time.

9. A method for repairing a component, said method comprising:
applying a fluoride mixture to a first portion of the component such that the fluoride mixture is compressed into a crack in the component to be repaired and such that the remainder of the component is not contacted by the fluoride mixture;
heat-treating the portion of the component including the fluoride mixture for a pre-determined period of time;
repairing the crack; and
removing excess material from the component until the repaired surface of the component is returned to pre-determined dimensions.

10. A method in accordance with claim 9 wherein applying a fluoride mixture to a first portion of the component further comprises cleaning the component to facilitate removing contaminants from the outer surface of the component adjacent the crack to be repaired.

11. A method in accordance with claim 12 wherein applying a fluoride mixture to a first portion of the component further comprises applying at least one of a fluoride mixture paste and a fluoride mixture compressed tape into the crack.

12. A method in accordance with claim 9 wherein heat-treating the portion of the component further comprises exposing the fluoride mixture to a controlled hydrogen atmosphere.

13. A method in accordance with claim 9 wherein heat-treating the portion of the component further comprises heat-treating the fluoride mixture in a controlled atmosphere having a temperature of between approximately 1800° F. and 2000° F. for a pre-determined period of time.

14. A method in accordance with claim 13 wherein heat-treating the fluoride mixture in a controlled atmosphere further comprises heat treating the fluoride mixture in a controlled atmosphere for period of time between approximately two to six hours.
